(19) United States
(12) Patent Application Publication
(10) Pub. No.: US 2017/0157750 A1
(43) Pub. Date: Jun. 8, 2017

(54) SKATEBOARD MULTI-PURPOSE TOOL

(71) Applicant: David Koenes, Kentwood, MI (US)

(72) Inventor: David Koenes, Kentwood, MI (US)

(21) Appl. No.: 15/371,939

(22) Filed: Dec. 7, 2016

Related U.S. Application Data
(60) Provisional application No. 62/263,858, filed on Dec. 7, 2015.

(51) Int. Cl. B25B 17/02; B25B 13/48; A63C 17/01; B25G 1/08

(52) U.S. Cl. CPC B25B 17/02; B25G 1/085; B25B 13/48; A63C 17/017

(57) ABSTRACT

A skateboard tool having a fastener-engaging piece and a nut-engaging piece which work cooperatively to unscrew multiple fasteners simultaneously. The fastener-engaging piece has a handle and a body. The handle is rigidly connected to a shaft which extends into the body and is rotatably connected with a set of interconnected gears. The handle and shaft are rotatable with respect to the body. The body also includes a plurality of fastener-engaging bits that are rotatably driven by the gears. The handle and shaft are rotated, which in turn rotates the gears and rotates the fastener-engaging bits. There is also provided a wrench for engaging, and rotatably locking, nuts secured to the fasteners that are rotated by the fastener-engaging bits. The wrench has an elongated U-shaped body having a pair of legs and a connector base piece. Each of the legs includes at least one nut-receiving socket.

### CROSS REFERENCE TO RELATED APPLICATION

This application claims the benefit of U.S. Provisional Application 62/263,858, which was filed on Dec. 7, 2015, the disclosure of which is hereby incorporated by reference.

### BACKGROUND OF THE INVENTION

1. Field of the Invention

The present invention pertains to a skateboard tool for removing the truck bolts from a skateboard. More particularly, the present invention pertains to a skateboard tool for simultaneously removing four truck bolts from a skateboard.

2. Description of the Prior Art

Skateboard tools are generally well-known for use with replacing or exchanging various components of a skateboard. As understood by those having ordinary skill in the art, skateboards include a deck upon which the user stands. Two separate trucks are attached to the underside of the deck using truck bolts and truck nuts. One of the trucks is positioned toward the front of the deck, and the other truck is positioned toward the rear of the deck, and the trucks are aligned so that the wheels all rotate in a single direction.

Each truck includes a base plate and a hanger, and the hanger pivots with respect to the base plate. This pivoting movement allows the user to steer the skateboard by leaning to the left or right on the deck. A kingpin and bushing are secured between the base plate and the hanger. A kingpin nut is attached to the end of the kingpin, and the tension of the kingpin nut on the kingpin determines how much force is necessary by the user to pivot the hanger with respect to the base plate.

Each hanger includes two axles which rotatably support the wheels. The axles have a threaded end, and a threaded axle nut is secured to the threaded end of each axle to hold the wheel onto the axle.

Skateboards can take great abuse from the user and it is understood that components on the skateboard can break with regular use of the board. Accordingly, skateboard tools are known in the prior art which have the various correctly-sized wrenches and screwdriver tips for working on skateboards. Some examples of these include U.S. Pat. No. 6,279,434 to Brown and U.S. Pat. No. 7,305,907 to Burwell.

However, each of the skateboard tools known in the prior art are relatively similar to each other and utilize a T-shaped design. This design requires each nut or bolt on the skateboard to be tightened or loosened individually, which can require an unnecessary amount of time to fix the skateboard. Skateboarders who ride regularly are the ones most often breaking their boards. These skateboarders also often fix their boards as soon as they break so that they can start riding again. Time spent fixing a skateboard is time not spent riding it, and therefore there is a desire to be able to fix skateboards faster.

Thus, there remains a need for a skateboard tool which allows the user to replace components on a skateboard faster.

The present invention, as is detailed hereinbelow, seeks to improve upon the existing skateboard tools by providing a skateboard tool having multiple fastener-engaging surfaces that are rotated simultaneously by a single rotational input crank, or handle.

### SUMMARY OF THE INVENTION

A first embodiment of the present invention provides a skateboard tool for simultaneously removing multiple fasteners on a skateboard deck in which each of the fasteners are secured into the skateboard by a nut on an end of the fastener. The skateboard tool comprises:

a handle having a bottom handle surface and a centrally-located shaft extending outwardly from the bottom surface;

a body having a top body surface, a bottom body surface, and body walls, the body houses a plurality of interconnected gears, one of the gears being a drive gear that is rotatably secured to, and driven by the shaft, and at least two of the gears being driven gears that are rotatably interconnected with the drive gear, at least one of the driven gears being secured to a fastener-engaging bit, the fastener-engaging bit extends outwardly from the bottom body surface; wherein the handle is rotatable, which in turn rotates the fastener-engaging bit via the interconnected drive gear and driven gears.

Optionally, the gears are spur gears.

Optionally, the handle has a top handle surface that includes a bit holder for securing a fastener-engaging bit.

Optionally, the body has five interconnected gears in total, in which one of the gears is the drive gear, and four of the gears are driven gears.

Optionally, the body includes at least seven interconnected gears, in which one of the gears is the drive gear, four of the gears are driven gears, and two of the gears are idler gears that are interposed between the drive gear and at least one of the driven gears.

Optionally, the handle has a storage compartment recessed into the bottom handle surface for storing fastener-engaging bits.

Optionally, the fastener-engaging bit is removable from the body, and the fastener-engaging bit is of the type selected from the group consisting of a flathead bit, a Philips head bit, a Torx® bit, and a hexagonal bit.

A second embodiment of the present invention provides, in combination, a skateboard tool for use with a skateboard comprising:

a fastener-driving section including a rotatable shaft having a handle, a body that is rotatably connected to the shaft, a plurality of rotatable fastener-engaging bits that extend outwardly from the body, and means for transferring the rotational movement of the shaft to the fastener-engaging bits; and

a nut-engaging section having a substantially U-shaped member, the U-shaped member having a plurality of sockets; wherein each of the sockets engages a respective nut that secures a fastener to the skateboard.

Preferably the means for transferring the rotational movement of the shaft to the fastener-engaging bits includes a set of interconnected gears, a set of sprockets interconnected by a chain, or a shaft having a bevel gear on each end for interconnecting the rotational movement between a pair of distanced bevel gears.

Optionally, the fastener-engaging bits are arranged to each engage with a fastener on a deck of a skateboard, and the sockets on the nut-engaging section are each arranged to engage with a nut beneath a truck on a skateboard, the nut being secured to an end of the fastener.

Optionally the fastener-driving section has four fastener-engaging bits, and the nut-engaging section has four sockets.

In a third embodiment of the present invention, there is provided a wrench for use on a skateboard comprising an elongated U-shaped body having a pair of legs and a connector base piece, each of the legs having a first end and a second end, the first ends being connected to the base piece, and each of the legs including at least one nut-receiving socket.

Optionally each of the legs includes at least two nut-receiving sockets, and the nut-receiving sockets are positioned along a single plane to permit the sockets to be placed over the nuts simultaneously.

Optionally, at least one of the legs includes a second nut-receiving socket extending outwardly therefrom.

Optionally, the wrench includes an outwardly-extending hexagonal bit.

Optionally, the nut-receiving sockets can include a magnetic material.

Optionally, one of the walls forming the second nut-receiving socket has a partial-hexagonal cut-out to receive a portion of a hexagonal nut.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a perspective view of a first embodiment of the present invention hereof showing the fastener-driving section and nut-engaging section;

FIG. 2 is a front view showing the fastener-driving section and nut-engaging section;

FIG. 3 is a side view showing the fastener-driving section and nut-engaging section;

FIG. 4 is a bottom perspective view showing the fastener-driving section and nut-engaging section;

FIG. 5 is a top view showing the fastener-driving section and nut-engaging section;

FIG. 6 is a bottom perspective view showing the fastener-driving section;

FIG. 7 is a front view showing the fastener-driving section;

FIG. 8 is a top perspective view of the fastener-driving section with the handle removed to show the shaft and body;

FIG. 9 is a top perspective view of the fastener-driving section with the handle removed to show the shaft and body view of the nut-engaging section, the walls and top surface of the body being shown in phantom to display the interconnected gears within the body;

FIG. 10 is a bottom perspective view of the body of the fastener-driving section showing the surfaces of the body in phantom to display the shaft, the interconnected gears, and the driven gears being connected to the fastener-engaging bits

FIG. 11 is a bottom perspective view of the handle showing recessed storage compartments;

FIG. 12 is a perspective of an alternate embodiment of the handle and interconnected gears with five gears;

FIG. 13 is a top perspective view of the U-shaped member;

FIG. 14 is a bottom perspective view of the U-shaped member;

FIG. 15 is an environmental view showing the U-shaped member secured over nuts securing a truck to a skateboard deck; and

FIG. 16 is a second environmental view showing the arrangement shown in FIG. 15 from a different angle.

### DETAILED DESCRIPTION OF THE PREFERRED EMBODIMENT

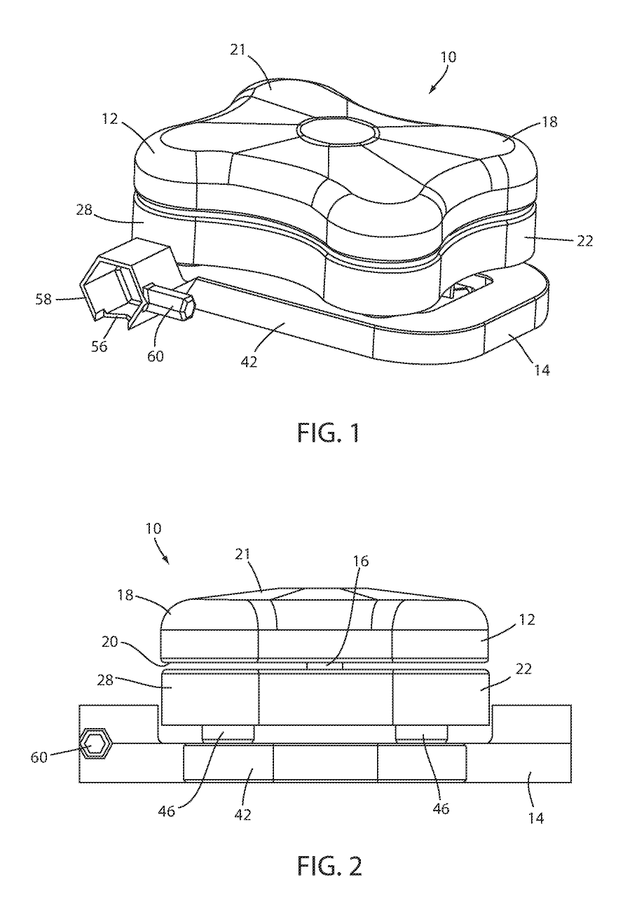

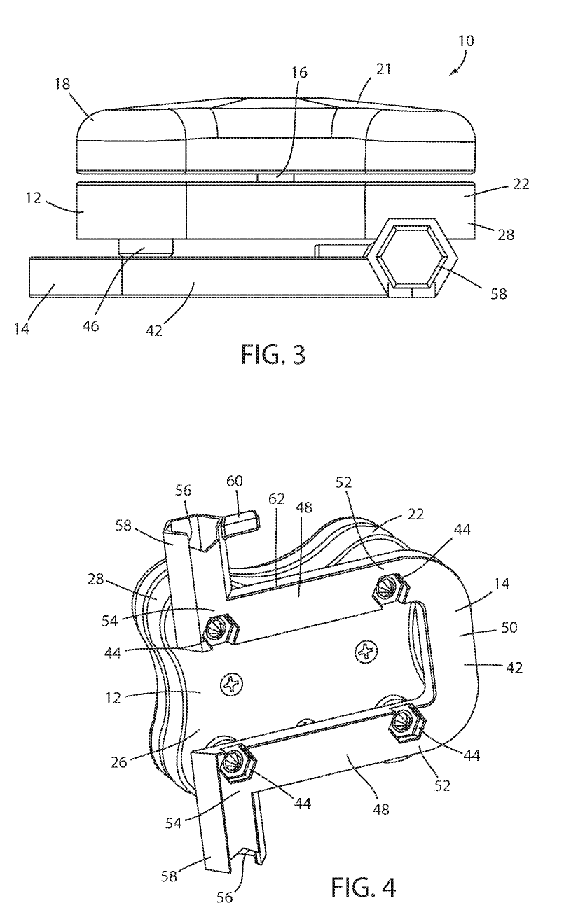

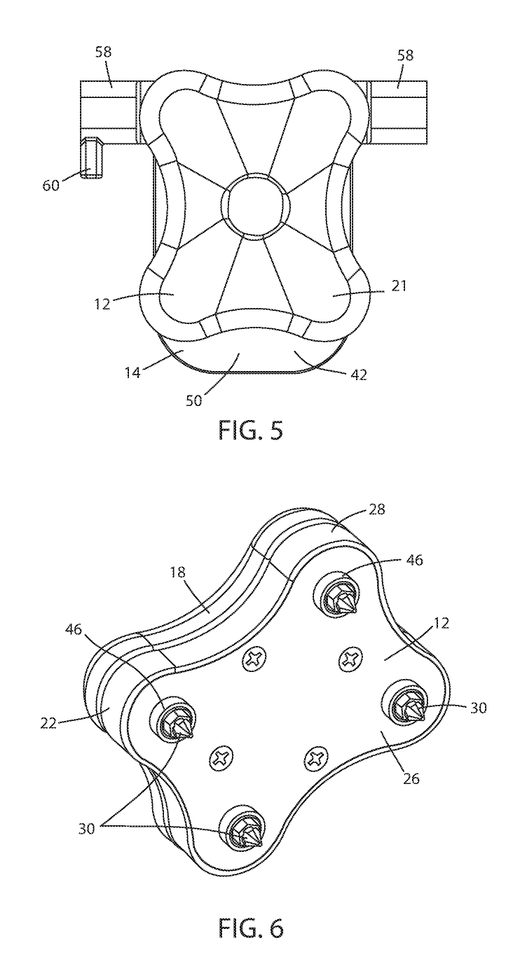

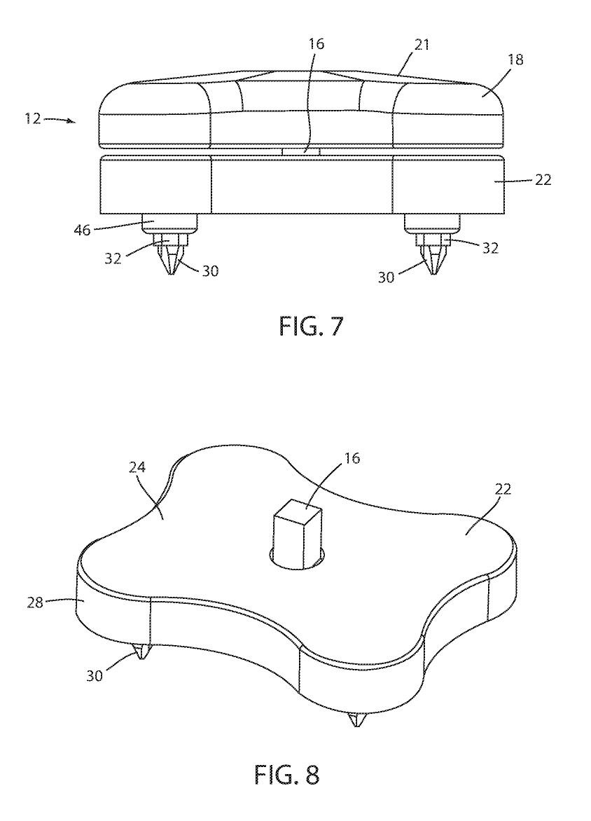

In accordance with the present invention, and as shown generally in FIG. 1, there is provided a skateboard tool 10 for simultaneously removing multiple fasteners on a deck of a skateboard in which each of the fasteners are secured into the skateboard by a nut on an end of the fastener. The skateboard tool 10 includes two separate parts: a fastener-driving section 12 for engaging the fasteners; and a nut-engaging section 14 for simultaneously holding the nuts in position while the fastener-driving section 12 rotates the fasteners.

The fastener-driving section 12 includes a rotatable shaft 16 having a handle 18. The shaft 16 is centrally-located along the handle 18 and extends outwardly from a bottom handle surface 20 of the handle 18. As discussed in greater detail below, the fasteners are rotated by the skateboard tool 10 when the rotatable shaft 16 is rotated by a user. The handle 18 is secured to the rotatable shaft 16 and is provided so that the user can easily manipulate and rotate the rotatable shaft 16 with his or her hand. The handle 18 can comprise any suitable type of device or shape, such as an oval or circular knob, a shaft that extends laterally outwardly, a plurality of laterally-extending offset shafts, or an ergonomically-shaped handle (such as the handle shown throughout the drawings), and so forth.

The handle 18 has a top handle surface 21 that can optionally include a bit holder (not shown) for securing a fastener-engaging bit 30. The bit holder atop the handle 18 may be provided to allow the user to turn the skateboard tool 10 upside down and use the fastener-engaging bit 30 on the top handle surface 21 to rotate a single fastener on the skateboard. This feature is not intended to be a primary function of the skateboard tool 10, but is more of an add-on feature lending to the multi-purpose nature of the tool 10.

As another feature, the bit holder atop the handle 18 can be rotatably connected to the shaft 16. In this regard, a bit from a power drill can be inserted into the bit holder atop the handle 18, and the power drill can then be used to rotate the bit holder, which in turn rotates the interconnected gears 34 and drives the fastener-engaging bits 30 extending downwardly from the body 22.

Alternatively, this additional bit holder can extend downwardly from the bottom body surface 26 of the body 22. Also, all but one of the fastener-engaging bits 30 can be removed from the body 22 so that the single remaining fastener-engaging bit 30 can be used to rotate a single fastener on the skateboard.

In addition, the bottom handle surface 20 of the handle 18 can include a recessed storage compartment 23 for storing fastener-engaging bits 30. The storage compartment 23 can have a door, or cover, for retaining the fastener-engaging bits 30 therein. Alternatively, a door or cover might not be provided, and the fastener-engaging bits 30 are retained within the storage compartment 23 using any other suitable means, such as a mechanical clip, a magnet, etc.

The fastener-driving section 12 also includes a body 22 having a top body surface 24, a bottom body surface 26, and body walls 28. The body 22 houses a plurality of interconnected gears 34. One of the gears 34 is a drive gear 36 that is rotatably secured to, and driven by the shaft 16. At least two of the gears 34 are driven gears 38 that are rotatably interconnected with the drive gear 36. The gears 34 can be any type of gears, although preferably the gears 34 are spur gears.

In one embodiment, and as shown in FIG. 12, the body 22 has five interconnected gears 34 in total, in which one of the gears 34 is the drive gear 36, and four of the gears 34 are driven gears 38 that are rotatably connected to, and driven by, the drive gear 36.

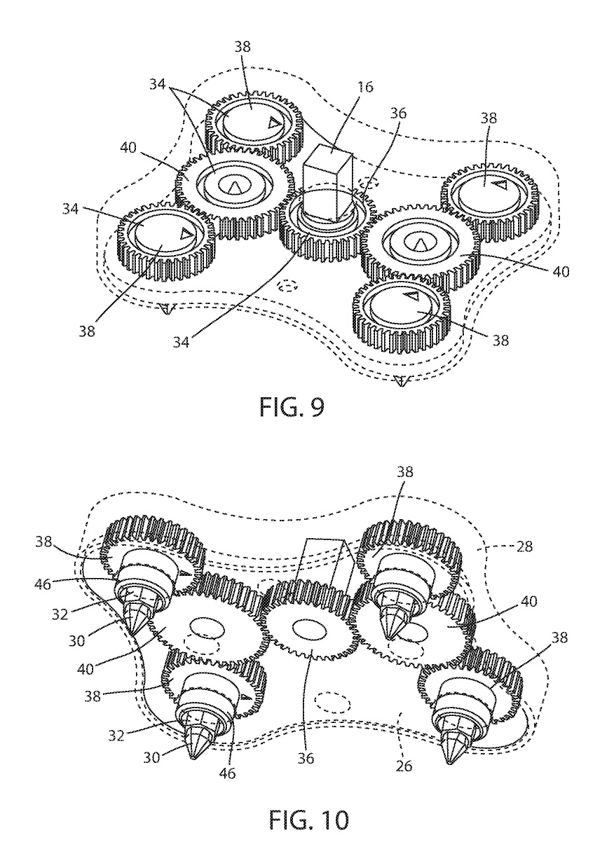

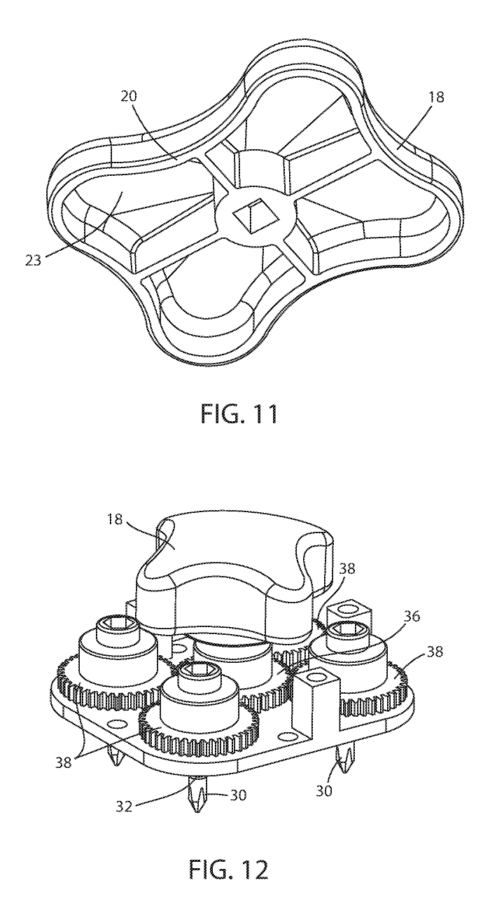

Preferably, and as shown in FIGS. 9 and 10, the body 22 includes at least seven interconnected gears 34, in which one of the gears 34 is the drive gear 36, four of the gears 34 are driven gears 38, and two of the gears 34 are idler gears 40. The idler gears 40 are interposed between the drive gear 36 and at least one of the driven gears 38. As shown, the drive gear 36 is directly connected to the idler gears 40, which are in turn connected directly to the driven gears 38. One advantage of this seven-gear configuration is that the drive gear 36 rotates in the same direction as the driven gears 38. Thus, the handle 18 and the fastener-engaging bits 30 will rotate in the same direction as each other, which is very intuitive for a user.

At least one of the driven gears 38 is secured to a fastener-engaging bit 30 which extends outwardly from the bottom body surface 26 of the body 22. The fastener-engaging bits 30 are mechanically coupled to and rotatably driven by the rotatable shaft 16. Although not necessarily, the fastener-engaging bits 30 are preferably removable and replaceable so that the user can use a flathead bit, a Philips head bit, a Torx® bit, a hexagonal bit, or any other suitable bit as necessary to engage the head of the fastener. When the bits 30 are removable, they can be secured to the driven gears 38 using any suitable type of mechanism that is well-known in the art for engaging removable bits.

For example, a collar 46 may be provided for engaging and retaining the fastener-engaging bits 30. And according to a separate aspect, or feature, of the skateboard multi-purpose tool 10, the fastener-engaging bit 30 and the collar 46 can be used to remove a bearing from a skateboard wheel. The fastener-engaging bit 30 can be inserted through a central axle hole in a bearing and the fastener-engaging bit 30 and the collar 46 can be used cooperatively to pry the bearing out of the skateboard wheel.

Furthermore, the collar 46 may optionally be spring-loaded so that the fastener-engaging bit 30 can be resiliently deflectable.

Optionally, each of the bits 30 may comprise a double-ended shaft 32 that has a particular type of bit 30 on each end. For example, the bits 30 may include a Philips head screwdriver on one end and a hexagonal Allen wrench bit on the other end. The bits 30 may optionally be magnetized to engage with the fasteners. It is understood that the bits 30 are sized appropriately to be used with fasteners that are customarily used with skateboards.

The bottom body surface 26 of the body 22 can optionally include a die (not shown) for rethreading an end of an axle. It is commonly understood to those having ordinary skill in the art that the end of an axle on a skateboard will often need to be re-threaded due to the significant amount of wear and use by the skateboard's rider. Therefore, a die may optionally be included to re-thread the end of the wheel's axle.

According to a second embodiment of the present invention, there is provided a skateboard tool 10 for use with a skateboard comprising: (1) a fastener-driving section 12 including a rotatable shaft 16 having a handle 18, a body 22 that is rotatably connected to the shaft 16, a plurality of rotatable fastener-engaging bits 30 that extend outwardly from the body 22, and means for transferring the rotational movement of the shaft 16 to the fastener-engaging bits 30; and (2) a nut-engaging section 14 having a substantially U-shaped member 42, the U-shaped member 42 having a plurality of sockets 44; wherein each of the sockets 44 engages a respective nut that secures a fastener to the skateboard.

Preferably the means for transferring the rotational movement of the shaft 16 to the fastener-engaging bits 30 can comprise a set of interconnected gears 34, a set of sprockets interconnected by a chain, a shaft having a bevel gear on each end for interconnecting the rotational movement between a pair of distanced bevel gears, or any other suitable type of device that is well-known for transferring rotational energy from a first point to a second point.

The fastener-engaging bits 30 may be arranged and positioned to engage with a fastener on a deck of a skateboard. As discussed in greater detail below, the sockets 44 on the nut-engaging section 14 can also each be arranged to engage with a nut beneath a truck on a skateboard, in which the nut is secured to an end of the fastener.

Preferably, the fastener-driving section 12 has four fastener-engaging bits 30, and the nut-engaging section 14 has four sockets 44. It is well-known by those having ordinary skill in the art that a truck is typically secured to a skateboard a deck using four bolts/screws and four accompanying nuts.

According to a third embodiment of the present invention, there is provided a wrench, or nut-engaging section 14, for use on a skateboard comprising an elongated rigid U-shaped body 22 having a pair of legs 48 and a connector base piece 50. Each of the legs 48 has a first end 52 and a second end 54. The first ends 52 are connected to the base piece 50, and each of the legs 48 include at least one nut-receiving socket 44 for engaging the nuts which secure the fasteners to the skateboard. The legs 48 also have a plurality of holes 49 that are aligned with the fastener-engaging bits 30 to permit the bits to pass therethrough for storage and when the tool 10 is not in use.

Preferably, each of the legs 48 includes at least two nut-receiving sockets 44. The nut-receiving sockets 44 are positioned along a single plane to permit the sockets 44 to be simultaneously placed over the nuts.

The nut-receiving sockets 44 are preferably hexagonal in shape to engage with hexagonally-shaped truck nuts. However, the sockets 44 can form any suitable geometry as necessary to engage the nuts. Preferably the sockets 44 extend from the U-shaped member 42 in a perpendicular direction. Alternatively, the sockets 44 are formed as recesses within the U-shaped member 42.

The sockets 44 can optionally include a magnetic material to attract ferrous metallic materials. For example, the magnetic material will retain the nuts within the sockets 44 which helps keep any nuts from getting lost, and also helps speed up the process of removing trucks from one skateboard deck and assembling the trucks onto a second deck. Any suitable type of magnetic material can be used herewith.

Optionally, the legs 48 can include an arched recess (not shown) to provide clearance with any raised lettering on the skateboard truck when the U-shaped member 42 is placed onto the truck to retain the nuts in position.

At least one of the legs 48 of the U-shaped member 42 can include a rounded-over edge 62 formed from hardened aluminum, or other suitable hardened material such as steel. As understood by those having ordinary skill in the art, this rounded-over edge 62 can be used to assist in installing new grip tape onto the deck of a skateboard. The rounded-over edge 62 can be used to score, or mark, the perimeter of the board beneath the new grip tape to allow the new grip tape to be correctly trimmed around the edges from the deck of the skateboard. The rounded-over edge 62 can optionally have a roughened, or textured surface, such as a knurled surface. Alternatively, a file insert (not shown) may be inset into the leg 48.

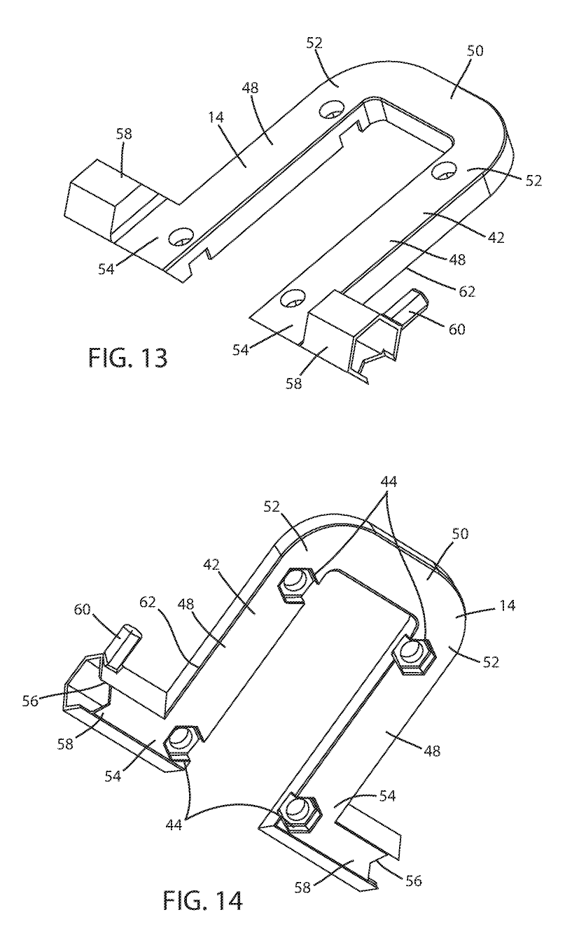

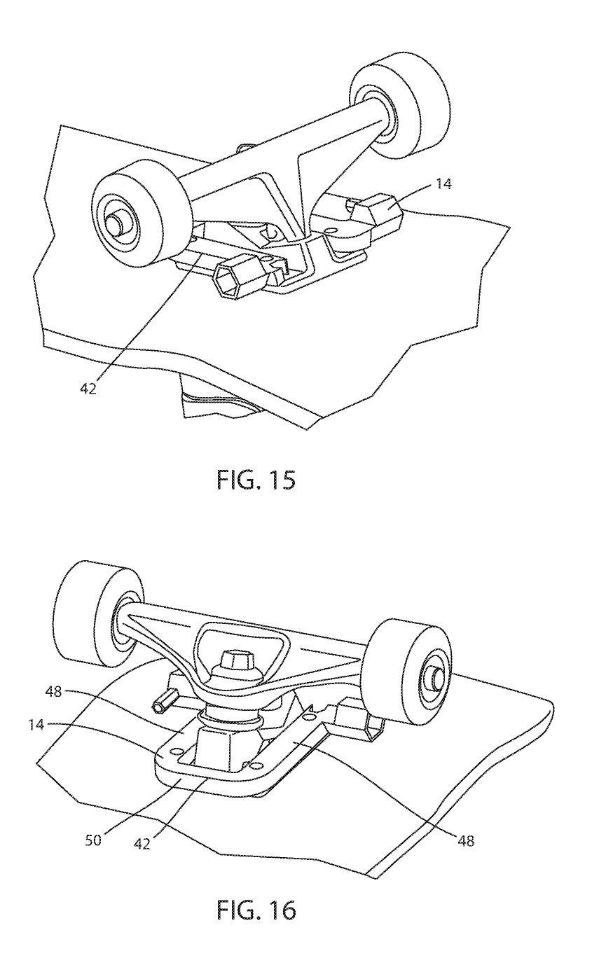

In addition, and as shown in FIGS. 13 and 14, one of the walls forming the second nut-receiving sockets 44 can have a partial-hexagonal cut-out 56 to receive a portion of a hexagonal nut. This cut-out 56 is provided to be engageable with the nuts secured to an end of the fastener. In order for the sockets 44 on the U-shaped member 42 to be placed onto the nuts, all of the nuts must substantially be oriented in the same direction as the sockets 44. The partial-hexagonal cut-out 56 can be used as a wrench to adjust any nuts as necessary to permit the sockets 44 to be placed over the nuts.

The U-shaped member 42 can be formed from a single rigid piece of material. Alternatively, the U-shaped member 42 can include two separate pieces (not shown) that are joined at the connector piece 50. When the U-shaped member 42 comprises two separate pieces, then a detachment mechanism can be used to attach or release the two pieces from each other as desired by the user. The detachment mechanism can be any suitable type of device that is well-known to those having ordinary skill in the art. For example, the detachment mechanism can include a lever or be “side button” activated.

Optionally, the U-shaped member 42 can include a second nut-receiving socket 58 at at least one of the ends for engaging a nut on the skateboard. The second socket 58 preferably extends outwardly from the end 52 of the leg 48. Preferably, one end 52 of the U-shaped member 42 includes a ½ inch wrench socket and the other end 52of the U-shaped member 42 includes a 9/16 inch wrench socket. Skateboards customarily include ½ inch nuts and 9/16 inch nuts, and therefore the nut-engaging section 14 can serve an additional purpose as a wrench. For example, the nut-engaging section 14 can then be used as a wrench for adjusting the kingpin nut or removing the axle nuts to exchange wheels.

In addition, the U-shaped member 42 can also optionally include an outwardly-extending hexagonal bit 60. The kingpin bolt on some skateboards has a female hexagonal bolt head, and therefore it may be beneficial in some instances to provide the outwardly-extending hexagonal bit 60 for use in adjusting the kingpin bolt.

The various components of the skateboard tool 10 are formed from any suitable type of materials that are well-known in the art, such as metals, plastics, and so forth. In addition, it is considered to be within the skill of one having ordinary skill in the art to use bearing surfaces, lubricants, and other mechanical retaining mechanisms to retain the moving parts described above in order to allow the skateboard tool 10 to function for its intended purpose.

In use, the skateboard tool 10 can be used to simultaneously remove four truck bolts from a skateboard to more quickly remove a truck from the deck. The nut-engaging section 14 is installed onto the truck with the four sockets 44 engaging with the truck nuts. The U-shaped member 42 permits the nut-engaging section 14 to be installed around the kingpin and the pivot bushing on the truck. Thus, the nut-engaging section 14 rotatably locks the four truck nuts in position.

Next, the fastener-driving section 12 is positioned above the deck and the bits 30 are aligned with, and into, the heads of the truck bolts. The user presses downwardly against the truck bolts and rotates the handle 18. The rotational movement of the handle 18 rotates each of the bits 30. Since the truck nuts are rotatably locked in position by the nut-engaging section 14, the four truck bolts are thus simultaneously rotated and removed at once. The truck is then secured to a new skateboard deck according to these same steps conducted in roughly reverse order.

According to the invention described above, the skateboard tool is provided having multiple fastener-engaging surfaces that are rotated simultaneously by a single rotational input crank.

What is claimed is:

1. A skateboard tool comprising:
a handle having a bottom handle surface and a centrally-located shaft extending outwardly from the bottom surface;
a body having a top body surface, a bottom body surface, and body walls, the body houses a plurality of interconnected gears, one of the gears being a drive gear that is rotatably secured to, and driven by the shaft, and at least two of the gears being driven gears that are rotatably interconnected with the drive gear, at least one of the driven gears being secured to a fastener-engaging bit, the fastener-engaging bit extends outwardly from the bottom body surface;
wherein the handle is rotatable, which in turn rotates the fastener-engaging bit via the interconnected drive gear and driven gears.

2. The skateboard tool of claim 1 wherein the gears are spur gears.

3. The skateboard tool of claim 1 wherein the handle has a handle surface that includes a bit holder for securing a fastener-engaging bit.

4. The skateboard tool of claim 1 wherein the body has five interconnected gears in total, one of the gears being the drive gear, and four of the gears being driven gears.

5. The skateboard tool of claim 4 wherein the gears are spur gears.

6. The skateboard tool of claim 1 wherein the body includes at least seven interconnected gears, one of the gears being the drive gear, four of the gears being driven gears, and two of the gears being idler gears that are interposed between the drive gear and at least one of the driven gears.

7. The skateboard tool of claim 6 wherein the gears are spur gears.

8. The skateboard tool of claim 7 wherein the body has five interconnected gears in total, one of the gears being the drive gear, and four of the gears being driven gears.

9. The skateboard tool of claim 1 wherein handle has a storage compartment recessed into the bottom handle surface for storing fastener-engaging bits.

10. The skateboard tool of claim 1 wherein the fastener-engaging bit is removable from the body, and the fastener-engaging bit is of the type selected from the group consisting of a flathead bit, a Philips head bit, a Torx® bit, and a hexagonal bit.

11. In combination, a skateboard tool for use with a skateboard comprising:
a fastener-driving section including a rotatable shaft having a handle, a body that is rotatably connected to the shaft, a plurality of rotatable fastener-engaging bits that extend outwardly from the body, and means for transferring the rotational movement of the shaft to the fastener-engaging bits; and
a nut-engaging section having a substantially U-shaped member, the U-shaped member having a plurality of sockets;
wherein each of the sockets engages a respective nut that secures a fastener to the skateboard.

12. The skateboard tool of claim 11 wherein the means for transferring the rotational movement of the shaft to the fastener-engaging bits is selected from the group consisting of:
a set of interconnected gears, a set of sprockets interconnected by a chain, and a shaft having a bevel gear on each end for interconnecting the rotational movement between a pair of distanced bevel gears.

13. The skateboard tool of claim 11 wherein the fastener-engaging bits are arranged to each engage with a fastener on a deck of a skateboard, and the sockets on the nut-engaging section are each arranged to engage with a nut beneath a truck on a skateboard, the nut being secured to an end of the fastener.

14. The skateboard tool of claim 11 wherein the fastener-driving section has four fastener-engaging bits, and the nut-engaging section has four sockets.

15. A wrench for use on a skateboard comprising:
an elongated U-shaped body having a pair of legs and a connector base piece, each of the legs having a first end and a second end, the first ends being connected to the base piece, and each of the legs including at least one nut-receiving socket.

16. The wrench of claim 15 wherein each of the legs includes at least two nut-receiving sockets, and the nut-receiving sockets are positioned along a single plane to permit the sockets to be simultaneously placed over nuts.

17. The wrench of claim 15 including a second nut-receiving socket extending outwardly from at least one of the legs.

18. The wrench of claim 15 including an outwardly-extending hexagonal bit.

19. The wrench of claim 15 wherein the nut-receiving sockets include a magnetic material.

20. The wrench of claim 17 wherein a wall forming the second nut-receiving socket has a partial-hexagonal cut-out to receive a portion of a hexagonal nut.
